(19) United States
(12) Patent Application Publication
(10) Pub. No.: US 2014/0089341 A1
(43) Pub. Date: Mar. 27, 2014

(54) COORDINATING DATA COLLECTION AMONG SYSTEM COMPONENTS

(71) Applicant: International Business Machines Corporation, Armonk, NY (US)

(72) Inventors: Vishal Chittranjan Aslot, Austin, TX (US); Brian W Hart, Austin, TX (US); Anil Kalavakolanu, Austin, TX (US); Evelyn Tingmay Yeung, Round Rock, TX (US)

(73) Assignee: International Business Machines Corporation, Armonk, NY (US)

(21) Appl. No.: 14/067,150

(22) Filed: Oct. 30, 2013

Related U.S. Application Data
(63) Continuation of application No. 12/957,033, filed on Nov. 30, 2010.

(51) Int. Cl. G06F 17/30

(52) U.S. Cl. CPC G06F 17/30424
USPC 707/769

(57) ABSTRACT

A method, computer program product and computer system for coordinating data collection from a component of a data processing system is disclosed. The component registers with a dispatcher, wherein the component is a computer resource of the data processing system and is configured to accept at least one query, and the registration comprising data types handled by the at least one component, wherein the dispatcher is allocated computer resources of the data processing system. The component receives from the dispatcher a notification to perform the query against specified data structures, wherein the query comprises an action. The component, responsive to receiving notification, determines whether data structures of a data type specified in the query are handled. The data processing system runs the query to determine whether the query is satisfied. The data processing system executes the action.

### BACKGROUND

This application claims the benefit of earlier-filed patent application serial number 12957033 filed on Nov. 30, 2010.

The present invention relates generally to a computer implemented method, data processing system, and computer program product for monitoring components of a data processing system. More specifically, the present invention relates to error root cause analysis based on components acting in response to queries on a data type basis.

A customer of a data center may be occupying a logical partition in a dynamic arrangement that permits flexibility of upgrading as software and new hardware resources become available. A frequent difficulty when using new software and/or hardware is that a small but significant number of field-discoverable bugs are in such new software and/or hardware. A bug is an anomalous condition that defeats the intended or advertised function of a software or hardware. The presence of bugs tends to diminish a vendor's reputation to a customer and can impact future sales. Although customers can tolerate a moderate level of bugs, frustration can mount when a bug is intermittent and cannot be repeatedly shown to occur.

### BRIEF SUMMARY

According to one illustrative embodiment, a method for coordinating data collection from a component of a data processing system is disclosed. The component registers with a dispatcher, wherein the component is a computer resource of the data processing system and is configured to accept at least one query, and the registration comprising data types handled by the at least one component, wherein the dispatcher is allocated computer resources of the data processing system. The component receives from the dispatcher a notification to perform the query against specified data structures, wherein the query comprises an action. The component, responsive to receiving notification, determines whether data structures of a data type specified in the query are handled. The data processing system runs the query to determine whether the query is satisfied, in response to determining that data structures of the type specified in the query are handled. The data processing system executes the action, in response to determining that the query is satisfied.

According to another illustrative embodiment, a computer program product comprising one or more computer-readable, tangible storage devices and computer-readable program instructions, which are stored on the one or more storage devices and when executed by one or more processors, perform the method just described.

According to another illustrative embodiment, a computer system comprising one or more processors, one or more computer-readable memories, one or more computer-readable, tangible storage devices and program instructions which are stored on the one or more storage devices for execution by the one or more processors via the one or more memories and when executed by the one or more processors perform the method just described.

According to another illustrative embodiment, a computer implemented method for coordinating data collection among multiple system components is disclosed. A subset of a set of components of a data processing system, configured to accept at least one query, registers with a dispatcher, wherein the registration comprises data types handled by the at least one component, wherein the dispatcher is allocated computer resources of the data processing system. The subset of components receives a notification, based on a data type of a query, to perform a query against specified data structures, wherein the query comprises an action. The subset of components determines whether data structures of the type specified in the query are handled, wherein the subset of components are computer resources of the data processing system, in response to receiving the notification. The subset of components runs the query to determine whether the query is satisfied, in response to one or more of the data types of the query being present in the component. The component executes the action in response to a determination that the query is satisfied.

According to another illustrative embodiment, a computer program product comprising one or more computer-readable, tangible storage devices and computer-readable program instructions which are stored on the one or more storage devices and when executed by one or more processors, perform the method just described.

According to another illustrative embodiment, a computer system comprising one or more processors, one or more computer-readable memories, one or more computer-readable, tangible storage devices and program instructions which are stored on the one or more storage devices for execution by the one or more processors via the one or more memories and when executed by the one or more processors perform the method just described.

According to another illustrative embodiment, a computer program product for coordinating data collection from a component of a data processing system is disclosed. The computer program product comprises one or more computer-readable, tangible storage devices within a data processing system, as well as a component and a dispatcher. Program instructions which are stored on at least one of the one or more tangible storage devices can be executed by the one or more processors to register the with a dispatcher, wherein the component is a computer resource of the data processing system and is configured to accept at least one query. Program instructions which are stored on at least one of the one or more tangible storage devices can be executed by the one or more processors to receive from the dispatcher, a notification to perform a query against specified data structures, wherein the query comprises an action. Program instructions which are stored on at least one of the one or more tangible storage devices, responsive to receiving the notification, to determine whether data structures of a data type specified in the query are handled. Program instructions which are stored on at least one of the one or more tangible storage devices, responsive to determining that data structures of the data type specified in the query are handled, to run the query to determine whether the query is satisfied. Program instructions which are stored on at least one of the one or more tangible storage devices, responsive to determining that the query is satisfied, to execute the action.

According to another illustrative embodiment, a computer system for coordinating the data collection from a component is disclosed. The computer system comprises one or more processors, one or more computer-readable memories and one or more computer-readable, tangible storage devices. Program instructions which are stored on at least one of the one or more tangible storage devices can be executed by the one or more processors to register the component with a dispatcher, wherein the component is configured to accept at least one query, and wherein the dispatcher is allocated computer resources of the data processing system. The data processing system performs program instructions which are stored on at least one of the one or more tangible storage devices, for execution by at least one of the one or more processors via at least one of the one or more memories, to receive from the dispatcher, a notification to perform a query against specified data structures, wherein the query comprises an action. The data processing system performs program instructions which are stored on at least one of the one or more tangible storage devices, for execution by at least one of the one or more processors via at least one of the one or more memories, responsive to receiving the notification, to determine whether data structures of a data type specified in the query are handled. The data processing system performs program instructions which are stored on at least one of the one or more tangible storage devices, for execution by at least one of the one or more processors via at least one of the one or more memories, responsive to determining that data structures of the data type specified in the query are handled, to run the query to determine whether the query is satisfied. The data processing system performs program instructions which are stored on at least one of the one or more tangible storage devices, for execution by at least one of the one or more processors via at least one of the one or more memories, responsive to determining that the query is satisfied, to execute the action.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in accordance with an illustrative embodiment of the invention;

FIG. 2 is a query data structure description and an example of a query data structure in accordance with an illustrative embodiment of the invention;

FIG. 3 is a architectural diagram of components of a data processing system in accordance with an illustrative embodiment of the invention;

FIG. 4A is a flowchart of a registration of a component with a dispatcher in accordance with an illustrative embodiment of the invention;

FIG. 4B is a flowchart for controlling and obtaining dispatcher output in accordance with an illustrative embodiment of the invention;

FIG. 4C is a flowchart of steps performed by components and a dispatcher in a logical partition within a data processing system in accordance with an illustrative embodiment of the invention; and

FIG. 5 is examples of queries that include an expiration in accordance with an illustrative embodiment of the invention.

### DETAILED DESCRIPTION

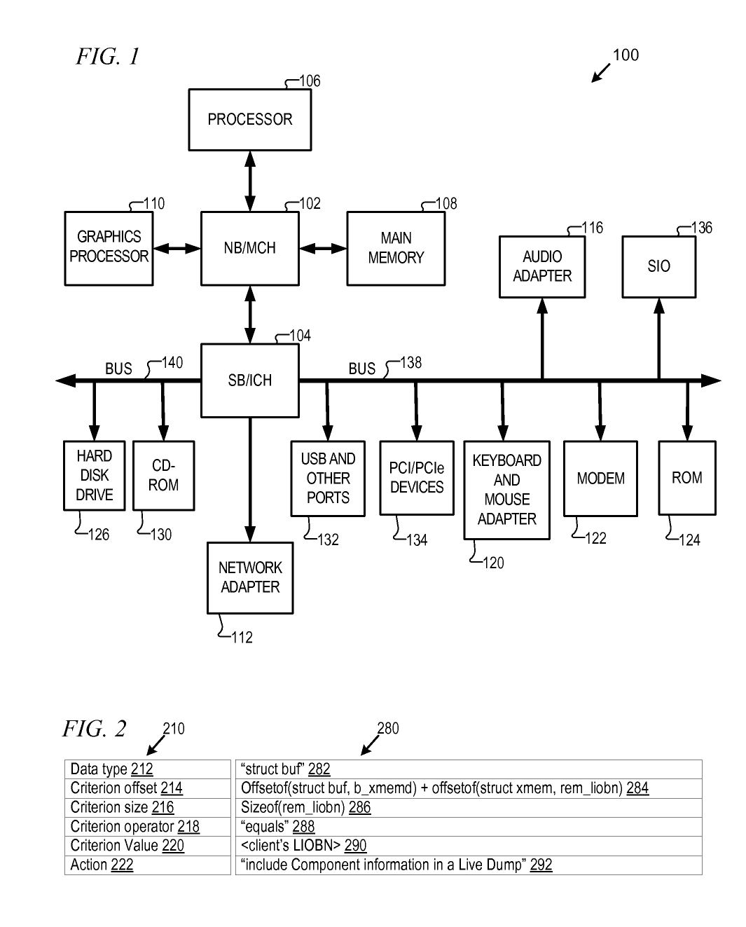

With reference now to the figures and in particular with reference to FIG. 1, a block diagram of a data processing system is shown in which aspects of an illustrative embodiment may be implemented. Data processing system 100 is an example of a computer, in which code or instructions implementing the processes of the present invention may be located. In the depicted example, data processing system 100 employs a hub architecture including a north bridge and memory controller hub (NB/MCH) 102 and a south bridge and input/output (I/O) controller hub (SB/ICH) 104. Processor 106, main memory 108, and graphics processor 110 connect to north bridge and memory controller hub 102. Graphics processor 110 may connect to the NB/MCH through an accelerated graphics port (AGP), for example.

In the depicted example, local area network (LAN) adapter 112 connects to south bridge and I/O controller hub 104 and audio adapter 116, keyboard and mouse adapter 120, modem 122, read only memory (ROM) 124, hard disk drive (HDD) 126, CD-ROM drive 130, universal serial bus (USB) ports and other communications ports 132, and PCl/PCIe devices 134 connect to south bridge and I/O controller hub 104 through bus 138 or bus 140. PCl/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be connected to south bridge and I/O controller hub 104.

An operating system runs on processor 106, and coordinates and provides control of various components within data processing system 100 in FIG. 1. The operating system may be a commercially available operating system such as Microsoft® Windows® XP. Microsoft and Windows are trademarks of Microsoft Corporation in the United States, other countries, or both. An object oriented programming system, such as the Java™ programming system, may run in conjunction with the operating system and provides calls to the operating system from Java™ programs or applications executing on data processing system 100. Java™ is a trademark or registered trademark of Oracle Corporation and/or its affiliates in the United States, other countries, or both.

Instructions for the operating system, the object-oriented programming system, and applications or programs are located on at least one of one or more computer readable tangible storage devices, such, for example, as hard disk drive 126 or CD-ROM 130, for execution by at least one of one or more processors, such as, for example, processor 106, via at least one of one or more computer readable memories, such as, for example, main memory 108, read only memory 124, or in one or more peripheral devices.

Those of ordinary skill in the art will appreciate that the hardware in FIG. 1 may vary depending on the implementation. Other internal hardware or peripheral devices, such as flash memory, equivalent non-volatile memory, and the like, may be used in addition to or in place of the hardware depicted in FIG. 1. In addition, the processes of the illustrative embodiments may be applied to a multiprocessor data processing system.

Among the configurations of the data processing system may be an arrangement where computer resources are allocated to one of several logical partitions by, for example, a hypervisor. A logical partition is an operating system image executing instructions on a data processing system in a manner that permits allocation of excess computer resources to a parallel or peer operating system image. Computer resources are any i/o facility, memory, storage, processor and the like, that can be apportioned to a logical partition. A logical partition is arranged so that, generally, a fault in another resource does not affect the operation of the logical partition. Accordingly, a data processing system can be the portion of resources allocated to a single logical partition.

In some illustrative examples, data processing system 100 may be a personal digital assistant (PDA), which is configured with flash memory to provide non-volatile memory for storing operating system files and/or user-generated data. A bus system may be comprised of one or more buses, such as a system bus, an I/O bus, and a PCI bus. Of course, the bus system may be implemented using any type of communications fabric or architecture that provides for a transfer of data between different components or devices attached to the fabric or architecture. A communication unit may include one or more devices used to transmit and receive data, such as a modem or a network adapter. A memory may be, for example, main memory 108 or a cache such as found in north bridge and memory controller hub 102. A processing unit may include one or more processors or CPUs. The depicted example in FIG. 1 is not meant to imply architectural limitations. For example, data processing system 100 also may be a tablet computer, laptop computer, or telephone device in addition to taking the form of a PDA.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention is presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) having computer readable program code embodied thereon.

Any combination of one or more computer readable storage device(s) may be utilized. More specific examples (a non-exhaustive list) of the computer readable storage device would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible storage device that can store a program for use by or in connection with an instruction execution system, apparatus, or device. The term “computer-readable storage device” does not encompass a signal propagation media such as a copper transmission cable, a optical transmission fiber or wireless transmission media.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable device that can direct a computer, other programmable data processing apparatus, or other devices to function in a particular manner, such that the instructions stored in the computer readable device produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In the course of developing the present invention, the inventors found that logging affected system errors can suffer one of two problems. First, the volume of logged messages may be set to a rough-gradation of ‘verbosity’ that produces so much data, that data logging suffers from log-wrap, where only a brief time interval of error root cause is captured before further logging, of irrelevant information, fills the buffer and is, in turn, directed to be collected in the place where relevant information was stored. Second, the volume of logged messages may be set to such a low setting that insufficient data is collected concerning the error within each component that contributes to the error (or could be used to detect the error). Accordingly, signals that might be relevant are never caught and logged. These conditions, of too much information and too little information, can make root cause determination problematic.

The term “component,” as used above, refers to physical hardware that can plug into a data processing system, or a counterpart executable program, such as a driver, stack layer, etc., specifically associated with or supporting the physical hardware, and executing in a machine. A component controls memory, either within a pool of memory of a data processing system, or a cache of memory located in a pluggable hardware module. A component can execute during the lifetime that a hardware module is configured and active and may residually execute to describe an inactive error state or disabled state for the hardware module. A component may be, for example, a disk adapter driver; a disk drive; a memory; a physical network interface card (NIC) adapter; a NIC driver; TCP/IP stack, etc. A component can have a segment of memory allocated to it for error logging. Such a log can be arranged as a circular buffer.

Components handle various data structure types as part of their normal operation. For example, a component that is a member of a TCP/IP networking stack may handle “struct mbuf” data structures. In another example, a component that is a disk driver may handle “struct buf” data structures.

The illustrative embodiments permit communications within at least one logical partition to make component queries to a component to elicit responses from the component concerning errors and status of data structures handled by the component. The component queries can be embodied within query data structures comprising criteria. Responses to the component queries, including actions conditioned on the criteria being met, can be narrowly focused to data structures handled by the component that are of interest to analyze and debug errors and other anomalous system conditions so that root causes can be determined.

FIG. 2 is a query data structure description and an example of a query data structure in accordance with an illustrative embodiment of the invention. The query data structure can be stored within memory while the query data structure is being created or evaluated. Similarly, the query data structure can be serialized and transmitted in a message, such as, by way of inter-process communication. The query data structure may have six data fields, which are described generally by name in query data structure description 210 as data type 212, criterion offset 214, criterion size 216, criterion operator 218, criterion value 220 and action 222. A specific example of data that may populate each of the six data fields is shown in query data structure 280.

Data type 212 is a name or pre-selected word or value that uniquely distinguishes the type of data structure, handled by a component, to which the query data structure is directed. In other words, the query data structure itself refers to still further data structures, and the ‘data type’ field is a descriptor of an initial, and possibly broad, criteria to distinguish the sought-after data structures handled by the component from those that are irrelevant to a component query. Data type 212 can be selected from among the many data structure types that are known to be available in the data processing system comprising the components. Two examples from the Unix computer operating system are the “struct buf” data structure type and the “struct mbuf” data structure type. A struct buf describes a memory buffer that will participate in a transfer to or from a block I/O device such as a disk drive. In the example of query data structure 280, data type 282 is “struct buf.” A struct mbuf describes a memory buffer that is used to store data in the kernel for incoming and outbound network traffic.

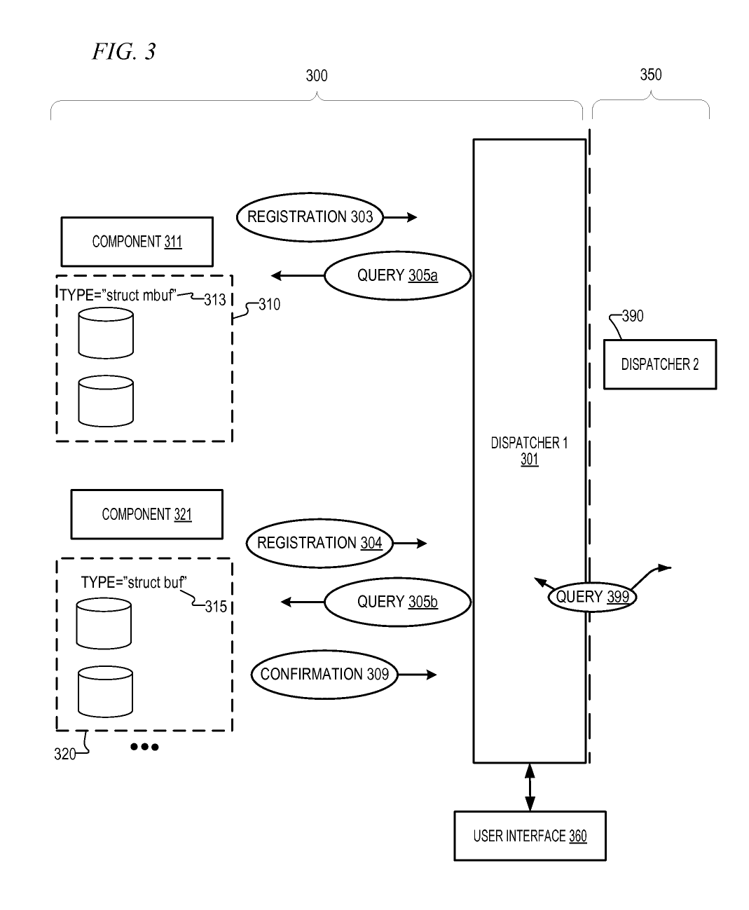

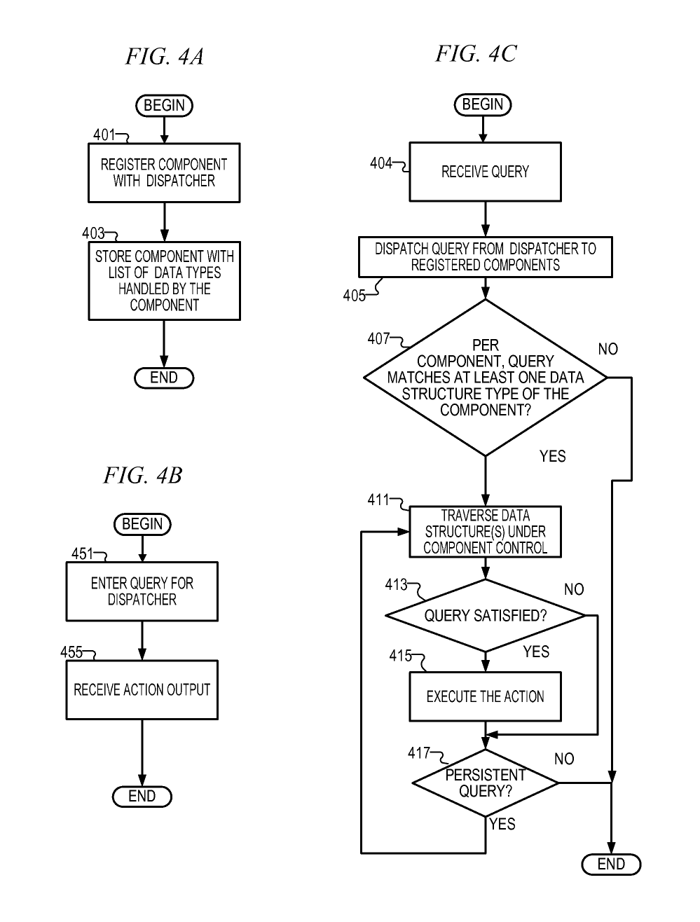

Criterion offset 214 is an integer that indicates the position within a data structure handled by the component that contains details relevant to the component query. Criterion offset 214 can be represented by an expression in a form that is convenient for a user of the computer operating system. In the example of query data structure 280, the target of the component query is the “rem_liobn” member of data structure type “struct xmem” which is itself a member (named “b_xmemd”) of data structure type “struct buf”. Criterion offset 284 of query data structure 280 is represented by an expression that adds the offset of rem_liobn within struct xmem to the offset of b_xmemd within struct buf to arrive at the offset of rem_liobn within struct buf Evaluation of the expression representing criterion offset 284 may take place within the component, a dispatcher, or in a pre-processor that packages the query for submission to the dispatcher. A dispatcher is a data processing system executing instructions to perform at least some of the functions as described in FIGS. 4A-C, below, to coordinate collection of information among several components. The data processing system may be data processing system 100 of FIG. 1. The function and design of components are described further in FIG. 3, below.

Criterion size 216 is an integer that informs the component of the length of data that linearly extends from criterion offset 214. Criterion size 216 can be represented by an expression in a form that is convenient for a user of the computer operating system. In the example of query data structure 280, the expression “sizeof(rem_liobn)” of criterion size 286 represents the size in bytes of the rem_liobn member of data structure struct xmem. Evaluation of the expression representing criterion size 286 may take place within the component, the dispatcher, or in the pre-processor that packages the query for submission to the dispatcher.

Criterion operator 218 represents a comparator function that determines a match between the query data structure and a data structure handled by the component based on logical or mathematical evaluation by the component. In the example of query data structure 280, criterion operator 288 of query data structure 280 is equals (“=”). Alternative examples of criterion operator 218 include less than, greater than, etc. Further examples of criterion operator 218 can include, alternatively, or in addition to, AND, OR, XOR, NAND, etc.

Criterion value 220 is any number, expressed in integer or floating point form, data value or logical value. The size of criterion value 220 is described by criterion size 216. In the example of query data structure 280, criterion value 290 of query data structure 280 is a “liobn” value that matches (given the criterion operation “equals”) the rem_liobn of interest. Appropriate criterion values and criterion operators for testing logical conditions may vary depending on the programming environment. For example, in the “C” programming language the logical value “true” is represented by any non-zero value. A test for logical true in that environment might use criterion operator “not equals” and criterion value “0”.

Action 222 may be represented by a command that the component is expected to perform, for example, by using the physical resources of the logical partition from which the component is supported. The command will be performed if a data structure controlled by the component and the query data structure have the same data type 212 and if the data structure handled by the component meets the criterion, e.g., criterion offset 214, criterion size 216, criterion operator 218, and criterion value 220. Alternatively, action 222 may be represented by a small integer that maps to a set of pre-defined commands. For example, “1” can mean “return true”, and “2” can mean “log an error”. Action 222 may also be represented by a pointer to program code that the component is to execute. Action 222 may also be expressed in a form that is convenient to a user of the computer system. In the example, action 292 of query data structure 280 is “include component information in a live dump”. In other words, if the component determines that the criterion is met, it can initiate a live dump of the component. Dumping a component occurs when a data processing system makes a copy of the component's state, including a copy of any register contents, memory buffer contents, and data structures, for later analysis. A dump is typically written to an external storage device such as a disk drive, but could be retained in memory. A live dump is a dump that is performed without disruption, that is, without requiring that the component or computer operating system be restarted.

Alternative examples of action 292 include, for example, generating traces, logging an error, or returning a logical value, such as, “true”. Generating traces can include writing brief entries describing the current state of the component to a memory buffer or an external device. Logging an error can include transmitting a string or number back to the source of the query. Similarly, returning a logical value, such as returning “true,” can include the component dispatching a signal that indicates “true” to the dispatcher or other component that sends the query data structure.

An alternate embodiment form of the query data structure may rely on creating a pointer or other reference to a location in memory containing data that forms the criterion, e.g., criterion offset 214, criterion size 216, criterion operator 218, and criterion value 220. Thus, the content of such memory, if providing an alternative form to the structure of example query data structure 280 can be “offsetof(struct buf, b_xmemd)+offsetof(struct xmem, rem_liobn) for length sizeof(rem_liobn)=client's LIOBN”. Accordingly, the criterion can be a pointer to executable code, e.g., of the component. Thus, an alternative embodiment of query data structure 280 may replace at least criterion offset 284, criterion size 286, criterion operator 288 and criterion value 290 with a single field containing the pointer.

Executable code, e.g., of the component, may perform complex analysis of a data structure handled by the component to determine if the criterion in query data structure 280 matches; the analysis is not limited to comparison of a single region and value.

The query data structure, when serialized and transmitted, for example, along a bus in the data processing system, but within the logical partition, is called a query. Examples of these query data structures shown in action in FIG. 3, below.

FIG. 3 is an architectural diagram of components of a data processing system in accordance with an illustrative embodiment of the invention. A first logical partition 300 includes at least a portion of physical resources first described in FIG. 1. Such physical resources include, for example, a processor, possibly time-shared, memory, and storage. In addition, the data processing system 100 of FIG. 1 may include sufficient physical resources to host a second logical partition 350. A partition, such as first logical partition 300 or second logical partition 350 may have many components.

Component data allocations 310 include data structures associated, for example, with data structures of type “struct mbuf” 313. A component 311 that is a member of a TCP/IP networking stack may handle “struct mbuf” data structures. Component data allocations 320 include data structures associated, for example, with data structures of type “struct buf” 315. A second component 321 that is a disk driver may handle “struct buf” data structures. The data type field, e.g., data type 282 of query data structure 280, may be checked by the component when evaluating incoming queries. According to at least one illustrative embodiment of the invention, component 321 may respond only to queries that include the type “struct buf” within the query's “data type” field. Components may handle multiple data structure types and therefore may be responsive to queries for multiple data types.

Each component may register to dispatcher 301. Thus component 311 may form and transmit registration 303 to dispatcher 301. Similarly, component 321 may form and transmit registration 304 to dispatcher 301.

Dispatcher 301 relies on registrations such as registrations 303 and 304 to establish a list of components that can be queried, and optionally, identify the types of data structures that each component can access or otherwise handle. The registrations may each include such information as the address of the component and a list of data structure types that the component can handle. Accordingly, the dispatcher may dispatch query 305a and query 305b. Among the registered components that handle the queries, one or more may send back a confirmation, such as confirmation 309.

Alternative embodiments of the invention can include the dispatcher also directing queries outside the logical partition that supports the dispatcher. For example dispatcher 301 can transmit query 399 to second dispatcher 390 of second logical partition 350. Second dispatcher 350 can then dispatch query 399 to the appropriate components within second logical partition 350. Query 399 may then result in actions performed in second logical partition 350. For example, if query 399 specified an action of “log an error”, then components with data structures matching the criterion may log errors on second logical partition 350. Query 399 may also cause a result or string to be transmitted from second dispatcher 390 to first dispatcher 301. For example, if query 399 specified an action of “return true” then second dispatcher 390 may transmit a message containing “true” or “false” to first dispatcher 301, according to the responses from the components in second logical partition 350.

User interface 360 may be used to direct activity of one or more dispatchers, such as dispatcher 301. User interface 360 may rely at least on graphics processor 110 of FIG. 1 above. A user may formulate a query for a dispatcher and receive action outputs through user interface 360.

FIG. 4A is a flowchart of a registration of a component with a dispatcher in accordance with an illustrative embodiment of the invention. Initially, a component, such as component 311 or component 321 of FIG. 3, may register with a dispatcher, such as first dispatcher 301 or second dispatcher 390 of FIG. 3 (step 401). Next, the dispatcher may store the component identity with a list of data types handled by the component (step 403). These two steps may be performed in response to each added component. Processing terminates thereafter. Registration of a component with a dispatcher is a prerequisite to the component receiving queries, for example, in step 404 of FIG. 4C, below.

FIG. 4B is a flowchart for controlling and obtaining dispatcher output in accordance with an illustrative embodiment of the invention. The steps of FIG. 4B may be performed by a process executed by a data processing system, such as data processing system 100 of FIG. 1. The process for FIG. 4B may be interdependent to a process of the data processing system executing the steps of FIG. 4C, below. Initially, a user may formulate a query, such as query 305a or query 305b of FIG. 3, for a dispatcher, such as dispatcher 301 of FIG. 3 (step 451). The user may formulate the query using a user interface, such as user interface 360 of FIG. 3. Subsequently, the user, or at least the user interface, may receive action outputs (step 455). An action output may be, for example, the output of a component receiving the query, such as component 311 or component 321 of FIG. 3, from performing an action, such as action 292 of query data structure 280. An action output may be made in real-time, or be summarized periodically.

FIG. 4C is a flowchart of steps performed by components and a dispatcher in a logical partition within a data processing system in accordance with an illustrative embodiment of the invention. Each component may register with the dispatcher according to step 401 of FIG. 4A as a prerequisite. Each component that is registered with the dispatcher is a registered component. There is no more than one dispatcher per logical partition. Next, the dispatcher may receive a query, such as query 305a or query 305b of FIG. 3 (step 404).

This step may occur in response to the query being submitted to the dispatcher. Next, the dispatcher may dispatch the query to registered components (step 405). In a first embodiment, the dispatcher dispatches the query to all registered components. However, alternative embodiments may permit the dispatcher to dispatch the query to none, some, or all registered components by relying on a previously stored list that records which component handles which data types. In other words, a dispatcher of the alternative embodiments dispatches queries only to those registered components that handle data types of the query, without dispatching queries to those registered components that do not.

Accordingly, among the set of components, the alternate embodiment dispatcher dispatches queries to the subset of registered components that are screened on the basis of data types known to be associated with that subset of registered components.

Next, each registered component may determine, using resources of a logical partition, such as first logical partition 300 or second logical partition 350 of FIG. 3, whether the data type in the query, such as data type 282 of query data structure 280 of FIG. 2, matches at least one data structure type handled by the registered component (step 407).

Responsive to a negative determination, the receiving component takes no further action. A positive determination, however, can cause each registered component of the logical partition to apply the query to the data structures of the appropriate data type handled by the component or otherwise under the component's control. In addition, the component that determines that data structures of the appropriate data type are present, consistent with the query, may return a confirmation to the dispatcher. Steps 411 through 417 may be performed by multiple registered components in tandem.

Next, after positive determination at step 407, the registered component traverses the data structures of the appropriate data type under its control (step 411). It is possible that a data structure may be under the control of more than one component. In other words, the component may traverse each data structure in accordance with the query. Next, the registered component determines whether the query is satisfied (step 413). This step may be performed iteratively over each data structure handled by the component. The registered component determines whether the criterion of the query, e.g., criterion offset 284, criterion size 286, criterion operator 288, and criterion value 290 of FIG. 1, matches any of the data structures to determine whether the query is satisfied. If the criterion takes the form of a pointer to executable program code, then the registered component may use the pointer to execute that code, passing the code a pointer to the data structure as an argument. This step may be with respect to all data structures handled by or otherwise under the control of the registered component. Accordingly, if only one data structure meets the conditions of the query, the query is satisfied, unless the query requires multiple data structures to satisfy additional conditions.

A positive determination of step 413 causes the registered component to execute the action (step 415). The action can be, for example, action 292 of query data structure 280. Next, or after a negative determination at step 413, the registered component may determine whether the query is a persistent query (step 417). A persistent query is a query that expires after a period of time. In other words, the registered component may repeat querying the data structures (step 411) until the query is no longer persistent. A query is no longer persistent if its effective date or deadline has expired. Examples of queries that are persistent include a seventh field beyond those shown in query data structure description 210 of FIG. 2. The seventh field could include time-based definitions, such as, for example, “for the next 30 seconds”. Accordingly, while the time-based definition remains true, a positive branch from step 417 is taken to step 411. In an alternate embodiment, the component may apply the persistent query to each new data structure of the given type that comes under the control of the registered component for the duration of the persistent query.

If the query is not persistent, or has otherwise expired, the registered component takes no further action. After the dispatcher has dispatched the query to all of the appropriate registered components, and possibly to a second dispatcher, the dispatcher takes no further action, unless a confirmation or other action of the one or more components triggers an action.

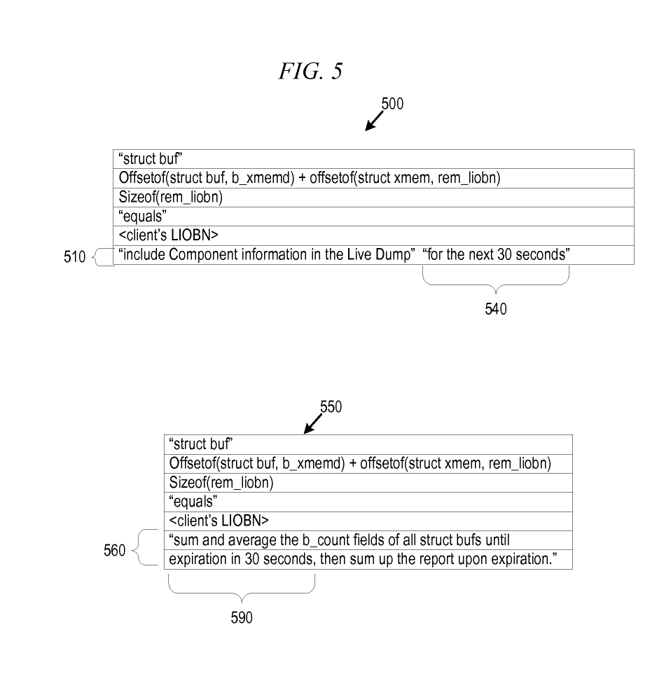

FIG. 5 shows examples of queries that include an expiration in accordance with an illustrative embodiment of the invention. Query 500 includes an action 510. Action 510 comprises an expiration expressed as time interval 540. Similarly, query 550 sets time interval as “expiration in 30 seconds” 590. The time interval 590 is set within the action 560.

A time interval may simply be an integer that indicates a number of units of time, or may be expressed in a form that is convenient for a user of a computer operating system.

An alternative form of the persistent query includes two part actions. The first action of the first part can be to routinely collect information prior to time interval expiration. As a second part, the logical partition can perform a second action, such as report summary results of the first action, based on the time interval expiration. The example two part action 560 may be stored as a pair of pointers that reference executable program code and an integer to represent the time. The first pointer points to code that would sum and average the b_count fields of a set of struct bufs, and the second pointer points to code that, when executed, reports the sum and average. The component can use the pointer to execute the averaging code as each new struct buf that it handles or comes under its control during the persistence interval. Furthermore, the component may use the second pointer to execute the reporting code when then interval expires.

Accordingly, illustrative embodiments may be used to selectively obtain data reporting from components. Users, who may formulate the queries, may request data types that are narrowly defined in scope and time. Consequently, in many cases, details concerning system operation, as may be needed following an error, can be scaled to a size that is easier to work with, being neither too large nor too small for analysis.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer usable or computer readable device providing program code for use by or in connection with a computer or any instruction execution system. For the purposes of this description, a computer usable or computer readable device can be any tangible apparatus that can store the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or computer readable tangible storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of managing queries, the method comprising:
a computer receiving a request to perform a query of a specified type of data structure for a predetermined time period, the request specifying the predetermined time period, and in response to the request, the computer determining that the computer does not currently control access to the specified type of data structure and as a result, the computer does not currently perform the query; and if the computer subsequently obtains control of access to the specified type of data structure before an end of the predetermined time period, the computer performing the query of the specified type of data structure,
if the computer does not subsequently obtain control of access to the specified type of data structure before the end of the predetermined time period, the computer does not perform the query of the specified type of data structure.

2. The method of claim 1, wherein the computer subsequently obtains control of access to the specified type of data structure before the end of the predetermined time period by storing the data structure in a disk storage allocated to the computer and for which the computer provides a disk driver, and in response, the computer performing the query of the specified type of data structure.

3. The method of claim 1, wherein the instructions referenced by a pointer specified in the query direct the computer to routinely attempt to obtain access to the specified type of data structure prior to the predetermined time period.

4. The method of claim 3, wherein the instructions referenced by the pointer comprise instructions for performing a live dump.

5. The method of claim 1, further comprising the step of a program within the computer registering with a dispatcher within the computer; and, in response to receiving a request to perform the query, the program sending a confirmation concerning receipt of the query to the dispatcher.

6. The method of claim 1, wherein the step of receiving a request to perform the query of the specified type of data structure for a predetermined time period comprises receiving the request from a first dispatcher, relayed through a second dispatcher, wherein the first dispatcher is in a first logical partition, and the second dispatcher is in a second logical partition.

7. The method of claim 1, wherein the type of data is a struct buf.

8. The method of claim 7, wherein a target of the query is a rem_liobn member.

9. A computer program product to manage queries, the computer program product comprising:
a computer readable storage device having computer readable program code stored thereon, the computer readable program code comprising:
computer readable program code to receive a request to perform a query of a specified type of data structure for a predetermined time period, the request specifying the predetermined time period, and in response to the request, the determine that the computer does not currently control access to the specified type of data structure and as a result, the computer does not currently perform the query; and if the computer subsequently obtains control of access to the specified type of data structure before the end of the predetermined time period, the computer performing the query of the specified data structure,
computer readable program code to not perform the query of the specified type of data structure, in response to subsequently not obtaining control of access to the specified type of data structure before the end of the predetermined time period.

10. The computer program product of claim 9, further comprising:
computer readable program code to perform the query of the specified type of data structure, in response to subsequently obtaining control of access to the specified type of data structure before the end of the predetermined time period by storing the data structure in a disk storage allocated to the computer and for which the computer provides a disk driver.

11. The computer program product of claim 10, wherein the computer readable program code to perform the query of the specified type of data structure comprises executing instructions, wherein the instructions referenced by a pointer specified in the query direct the computer to routinely attempt to obtain access to the specified type of data structure prior to the predetermined time period.

12. The computer program product of managing queries of claim 11, wherein the instructions referenced by the pointer comprise instructions for performing a live dump.

13. The computer program product of claim 9, further comprising:
computer readable program code to register a program within the computer with a dispatcher within the computer; and, in response to receiving a request to perform the query, the program sending a confirmation concerning receipt of the query to the dispatcher.

14. The computer program product of claim 9, wherein the computer readable program code to receive a request to perform the query of the specified type of data structure for a predetermined time period comprises computer readable program code to receive the request from a first dispatcher, relayed through a second dispatcher, wherein the dispatcher is in a first logical partition, and the second dispatcher is in a second logical partition.

15. The computer program product of claim 9, wherein the type of data is a struct buf.

16. The computer program product of claim 15, wherein a target of the query is a rem_liobn member.

17. A method of managing queries, the method comprising:
a first program and a second program registering with a dispatcher, as available to perform queries and subsequently,
the first program receiving from the dispatcher a request to perform a query, the query specifying a type of data to be searched, and in response, the first program determining that the first program can perform the query for data structures having the type of data, and in response,
the first program completing performance of the query, the first program writing a status of the first program to a first memory buffer; and
the second program receiving from the dispatcher the request to perform the query, and in response, the second program determining that the second program cannot perform the query for data structures having the type of data; and in response, the second program not writing a status of the second program to a second memory buffer that it would have written had the second program determined that the second program can perform the query for the data structures having the type of data.

18. The method of claim 17, wherein writing a status further comprises summarizing data satisfying the query in a report.
